(19) United States
(12) Patent Application Publication
(10) Pub. No.: US 2019/0042163 A1
(43) Pub. Date: Feb. 7, 2019

(54) EDGE CLOUD WIRELESS BYTE ADDRESSABLE POOLED MEMORY TIERED ARCHITECTURE

(71) Applicant: Intel Corporation, Santa Clara, CA (US)

(72) Inventor: Francesc GUIM BERNAT, Barcelona (ES)

(21) Appl. No.: 15/975,704

(22) Filed: May 9, 2018

(51) Int. Cl. G06F 3/06; H04L 29/08; G06F 9/50

(52) U.S. Cl. CPC G06F 3/0683; H04L 67/1051; G06F 3/067; G06F 3/0604; G06F 3/0659; G06F 9/5077

(57) ABSTRACT

Examples include a first tier system including a pooled memory having a plurality of memories, and a pooled memory controller coupled to the pooled memory, edge devices, and a second tier system. The pooled memory controller includes logic to receive a request from an edge device or the second tier system to access the pooled memory, the request including a virtual address; to determine if the request is to be forwarded to the second tier system; to forward the request to the second tier system when the request is to be forwarded; and when the request is to not be forwarded, translating the virtual address to a local physical address of a selected memory of the pooled memory, and performing at least one of a read operation and a write operation on the local physical address of the selected memory of the pooled memory based on the request.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Examples described herein are generally related to techniques used by a cloud computing memory architecture.

### BACKGROUND

In computing, edge cloud architectures are emerging as one of the potential areas where computing system architectures can have an opportunity to enable new use cases that have not yet been possible. One important area of computing is known as the Internet of Things (IoT). In this big domain, multiple types of use cases are expected to benefit from edge cloud architectures, such as manufacturing, aviation (including unmanned aviation), autonomous driving systems, and those use cases resulting from the widespread adoption of fifth generation (5G) cellular networks.

In IoT, one of the relevant functions of the edge cloud is to facilitate data management and sharing across all of the different types of computing devices. In this context there are some requirements that are important for data storage in the IoT segment: (1) allow data sharing across multiple IoT devices; (2) allow storage of larger data sets in a secure and reliable way; and (3) provide scalable and extensible data storage.

Current IoT technologies and edge cloud architectures attempt to address these requirements by providing reliable, secure and scalable storage solutions based on existing technologies such as solid-state drives (SSDs), hard disk drives (HDDs), and the Non-Volatile Memory Express (NVMe) Specification, revision 1.3a, also published in October 2017 (“NVMe specification”) or later revisions (available at www.nvmexpress.org). These solutions may be acceptable for warm and cold data. However, storage and retrieval of hot data is problematic. Current edge cloud architectures do not provide for storing large quantities of hot data in edge devices (which typically have limited internal memory), for accessing hot data in a fine granular way (such as byte addressable accesses), and for sharing hot data among multiple IoT devices in a coherent or consistent way using addressable memory.

### BRIEF DESCRIPTION OF THE DRAWINGS

FIG. 1 illustrates an example first computing system.

FIG. 2 illustrates an example of a tier 1 system.

FIG. 3 illustrates an example of a tier 2 system.

FIG. 4 illustrates an example of a tire 3 system.

FIG. 5 illustrates an example of an edge device coupled to a tier system.

FIG. 6 illustrates an example set of memory pool interface operations.

FIG. 7 illustrates an example logic flow of a pooled memory controller.

FIG. 8 illustrates an example second computing system.

### DETAILED DESCRIPTION

As contemplated in the present disclosure, embodiments of the present invention comprise a computer system architecture to bring memory tiers closer to edge devices having lower latency access requirements with a pooled memory accessible by the edge devices. In embodiments, the computing system architecture: (1) in a transparent way exposes device network adapters as home agents; (2) provides for access to memory to be byte addressable as with local memory; (2) is movement aware with automatic migration schemes across base stations/small cells; (3) provides geo-interfaces that allow allocating and managing memory in specific base stations/small cells.

Existing technologies do not expose pooled memory at the edge of the network accessible via 5G protocols. Thus, existing data edge management solutions lack byte addressable solutions that allow accessing data like any other type of local memory. In contrast, embodiments of the present invention are: (1) edge aware—the system knows where hot data is stored (e.g., a specific base station) and how (e.g., taking into account reliability, quality of service (QoS), etc.); 2) edge tier aware—depending on the QoS or service level agreement (SLA) and billing requirements, hot data can be stored in pooled memory on a small cell, a base station or central office equipment; 3) motion aware—hot data can be moved from pooled memory to pooled memory as an edge device moves; 4) scalable—an edge device can scale up or down assigned pooled memory depending on the edge device needs; and 5) shareable—edge devices connected to the same small cells, base station or central offices can share address spaces.

Embodiments of the present invention expose a pool of memory tiers hosted in the different edge tiers (such as small cells, base station and central offices) to the edge devices. Note that having addressable memory closer to edge device (i.e., a small cell) has a benefit of low latency (but at higher cost). Having memory accessible by inner tiers has the benefit that memory can be shared with more edge devices across a geographic area, with more capacity, without the need of migration, and at lower cost.

To use the present pooled memory scheme, the computing system architecture exposes interfaces to edge devices for at least several advantages. Extended network access logic in the edge device may expose pooled memory as another local home agent within the edge device. Using the home agent as a current agent exposes meta-data that can be used to identify memory characteristics (e.g., how far away the memory is in the system architecture, security features, etc.). Memory chunks that are allocated in a pooled memory may be stored in a particular small cell, base station, central office, core of the network, or any intermediate point of aggregation between the edge device and the core of the network. Functional and performance requirements (e.g., security, reliability, QoS/SLA, etc.) associated with memory regions that are used by pooled memory controllers may be used to decide where data needs to be stored (i.e., which tier), if the data needs to be replicated in multiple independent memory pools, and how secure the data is to be stored and what SLA or QoS requirements the edge device has for that memory. Embodiments of the present invention provide a mechanism to share specific memory regions with multiple edge devices. Embodiments also provide a mechanism to specify that particular memory regions need to be migrated from one location (e.g., a base station) to another when the edge device changes a point of access to the pooled memory.

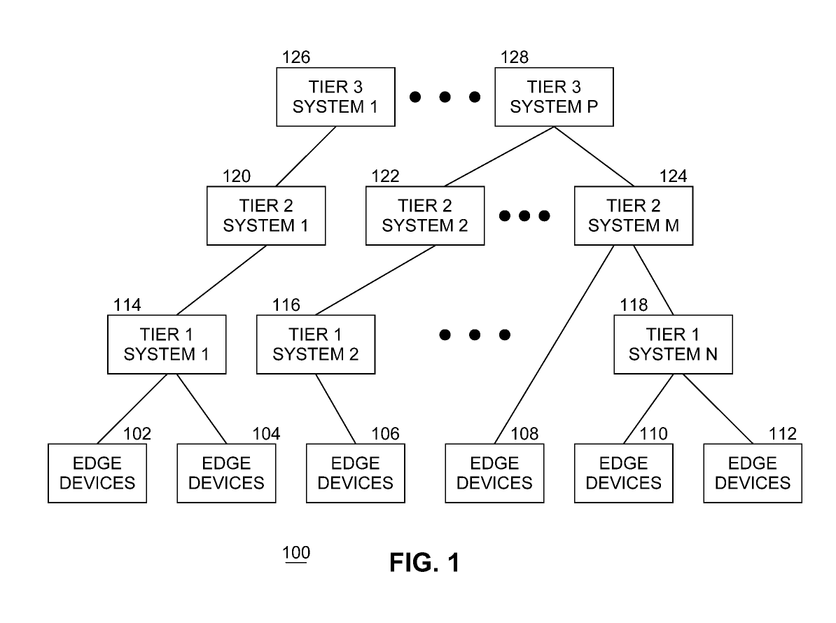

FIG. 1 illustrates an example first computing system 100. Embodiments of the present invention provide a new computing system architecture for how edge cloud applications running on edge devices share and store hot data. Computing system 100 may include a plurality of edge devices 102, 104, 106, 108, 110, and 112. Although only a few edge devices are shown in FIG. 1, they are representative of any number of edge devices. For example, the number of edge devices in computing system 100 may be in the thousands, millions, or even billions of edge devices. An edge device may be any device capable of computing data and communicating with other system components either wirelessly or via a wired connection. For example, in an embodiment an edge device may be a cellular mobile telephone such as a smartphone. In another embodiment, an edge device may be a device including a sensor and computing capability in an IoT network. Many other edge devices are contemplated and embodiments of the present invention are not limited in this respect. As shown, computing system 100 includes three tiers (not counting the edge devices as “leaf” nodes in the tree structure of FIG. 1), although in other embodiments, other numbers of tiers may be used. In embodiments, there may be any number of tier systems in each tier. That is, there may be, for example, any number “N” of tier 1 systems, any number “M” of tier 2 systems, and any number “P” of tier 3 systems, where N, M, and P are natural numbers. In an embodiment, the number of edge devices may be greater than the number N of tier 1 systems, the number N of tier 1 systems may be greater than the number M of tier 2 systems, and the number M of tier 2 systems may be greater than the number P of tier 3 systems. Each tier system may communicate with another tier system either wirelessly or via a wired connection. The computing system architecture of embodiments of the present invention is scalable and extensible to any size and geographic area. In one embodiment, the computing system architecture may encompass a geographic area as large as the Earth and include as many tier 1, tier 2, and tier 3 systems as are needed to meet system requirements for service to edge devices. In an embodiment, a tier 1 system may communicate with a single tier 2 system and multiple other tier 1 systems, and a tier 2 system may communicate with a single tier 3 system and multiple other tier 2 systems, and a tier 3 system may communicate with other tier 3 systems. For example, tier 1 system 1 114 may communicate with tier 2 system 1 120, which may in turn communicate with tier 3 system 1 126, and so on as shown in the example tree structure of FIG. 1.

A tier 1 system such as tier 1 system 1 114 may communicate “downstream” with any number edge devices, such as edge devices 102, 104, and “upstream” with a tier 2 system such as tier 2 system 1 120. In further examples, edge devices 106 may communicate with tier 1 system 2 116, and edge devices 110, 112 may communicate with tier 1 system N 118. In an embodiment, the number of edge devices that a tier 1 system communicates with may be limited by the computational and communication capacity of the tier 1 system. In an embodiment, edge devices may also communicate directly with a tier 2 system, such as is shown for edge devices 108 and tier 2 system M 124. Thus, a tier 2 system may communicate “downstream” with edge devices and/or tier 1 systems, and also “upstream” with a tier 3 system.

In computing system 100, edge devices may be stationary or mobile. When edge devices are mobile (such as smartphones, for example), edge devices may communicate at times with different tier 1 systems as the edge devices move around in different geographic areas. Each edge device communicates with only one tier system at a time. When edge devices are stationary, they may communicate with a specific tier 1 system or tier 2 system allocated to the geographic area where the edge device is located.

In one embodiment, a tier 1 system (such as tier 1 system 1 114) may be known as a small cell. Small cells are low-powered cellular radio access nodes (RANs) that operate in licensed and unlicensed spectrum that have a range of 10 meters within urban and in-building locations to a few kilometers in rural locations. They are “small” compared to a mobile macro-cell, partly because they have a shorter range and partly because they typically handle fewer concurrent calls or sessions. They make best use of available spectrum by re-using the same frequencies many times within a geographical area. Fewer new macro-cell sites are being built, with larger numbers of small cells recognized as an important method of increasing cellular network capacity, quality and resilience with a growing focus using LTA Advanced and 5G. Small-cell networks can also be realized by means of distributed radio technology using centralized baseband units and remote radio heads. These approaches to small cells all feature central management by mobile network operators.

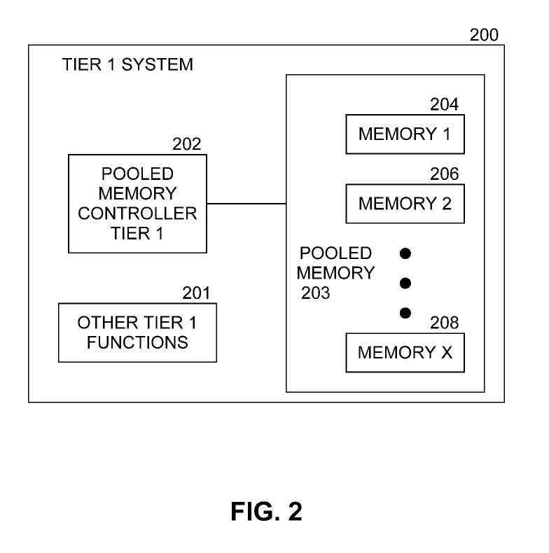

FIG. 2 illustrates an example of a tier 1 system 200. Tier 1 system 200 may include other tier 1 functions 201 logic to perform small cell functions as is known in the art. In embodiments of the present invention, tier 1 system 200 may also include a pooled memory controller tier 1 component 202 and pooled memory 203. A pooled memory controller comprises logic to manage access to a pooled memory 203 within a tier system, such as tier 1 system 200. Pooled memory 203 includes one or more byte addressable memory devices such as memory 1 204, memory 2 206, . . . memory X 208, where X is a natural number. Pooled memory 203 may include memory that may be accessed by edge devices and/or other tier 1 or tier 2 systems communicatively coupled to this tier 1 system. That is, edge devices and/or other tier 1 or tier 2 systems may read hot data from and/or write hot data to any one or more of the memories.

In some examples, any memory within pooled memory 203 may include volatile types of memory including, but not limited to, random-access memory (RAM), dynamic RAM (D-RAM), double data rate (DDR) SDRAM, SRAM, T-RAM or Z-RAM. One example of volatile memory includes DRAM, or some variant such as SDRAM. A memory subsystem as described herein may be compatible with a number of memory technologies, such as DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (LPDDR version 5, currently in discussion by JEDEC), HBM2 (HBM version 2, currently in discussion by JEDEC), and/or others, and technologies based on derivatives or extensions of such specifications.

However, examples are not limited in this manner, and in some instances, any memory within pooled memory 203 may include non-volatile types of memory, whose state is determinate even if power is interrupted to a memory. In some examples, memory may include non-volatile types of memory that is a block addressable, such as for NAND or NOR technologies. Thus, memory can also include a future generation of types of non-volatile memory, such as a 3-dimensional cross-point memory (3D XPoint™ commercially available from Intel Corporation), or other byte addressable non-volatile types of memory. According to some examples, memory may include types of non-volatile memory that includes chalcogenide glass, multi-threshold level NAND flash memory, NOR flash memory, single or multi-level Phase Change Memory (PCM), a resistive memory, nanowire memory, FeTRAM, MRAM that incorporates memristor technology, or STT-MRAM, or a combination of any of the above, or other memory.

In one embodiment, a tier 2 system (such as tier 2 system 1 120) may be known as a base station. In radio communications, a base station is a wireless communications station installed at a fixed location and used to communicate as part of a wireless telephone system. A wireless telephone base station communicates with a mobile or hand-held phone. For example, in a wireless telephone system, the signals from one or more mobile telephones in an area are received at a nearby base station, which then connects the call to the land-line network. A base station may also communicate with IoT edge devices.

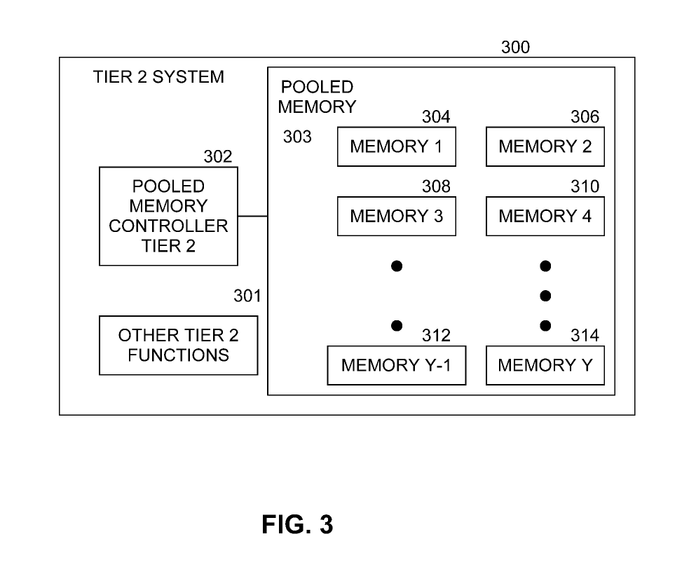

FIG. 3 illustrates an example of a tier 2 system. Tier 2 system 300 may include other tier 2 functions 301 to perform base station operations as is known in the art. In embodiments of the present invention, tier 2 system 300 may also include a pooled memory controller tier 2 component 302 and pooled memory 303. A pooled memory controller comprises logic to manage access to a pooled memory 303 within a tier system, such as tier 2 system 300. Pooled memory 303 includes one or more byte addressable memory devices such as memory 1 304, memory 2 306, memory 3 308, memory 4 310, . . . memory Y-1 312, and memory Y 314, where Y is a natural number. In an embodiment, the number of memories Y in a tier 2 system (e.g., a base station) may be more than the number of memories X in a tier 1 system (e.g., a small cell). Pooled memory 303 may include memory that may be accessed by edge devices and/or other tier 1 or tier 2 systems communicatively coupled to this tier 2 system. That is, edge devices and/or other tier 1 or tier 2 systems may read hot data from and/or write hot data to any one or more of the memories.

In some examples, any memory within pooled memory 303 may include volatile types of memory including, but not limited to, random-access memory (RAM), dynamic RAM (D-RAM), double data rate (DDR) SDRAM, SRAM, T-RAM or Z-RAM. One example of volatile memory includes DRAM, or some variant such as SDRAM. A memory subsystem as described herein may be compatible with a number of memory technologies, such as DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (LPDDR version 5, currently in discussion by JEDEC), HBM2 (HBM version 2, currently in discussion by JEDEC), and/or others, and technologies based on derivatives or extensions of such specifications.

However, examples are not limited in this manner, and in some instances, any memory within pooled memory 303 may include non-volatile types of memory, whose state is determinate even if power is interrupted to a memory. In some examples, memory may include non-volatile types of memory that is a block addressable, such as for NAND or NOR technologies. Thus, memory can also include a future generation of types of non-volatile memory, such as a 3-dimensional cross-point memory (3D XPoint™ commercially available from Intel Corporation), or other byte addressable non-volatile types of memory. According to some examples, memory may include types of non-volatile memory that includes chalcogenide glass, multi-threshold level NAND flash memory, NOR flash memory, single or multi-level Phase Change Memory (PCM), a resistive memory, nanowire memory, FeTRAM, MRAM that incorporates memristor technology, or STT-MRAM, or a combination of any of the above, or other memory.

In one embodiment, a tier 3 system (such as tier 3 system 1 126) may be known as a central office (CO) (i.e., the physical location of where a telephone call or other telephonic communication originates and ends). In telephone communication, a central office (also known as a public exchange, telephone switching center, wire cent, or telephone exchange) is an office in a locality to which subscriber home and business lines are connected on what is called a local loop. The central office has switching equipment that can switch calls locally or to long-distance carrier phone offices.

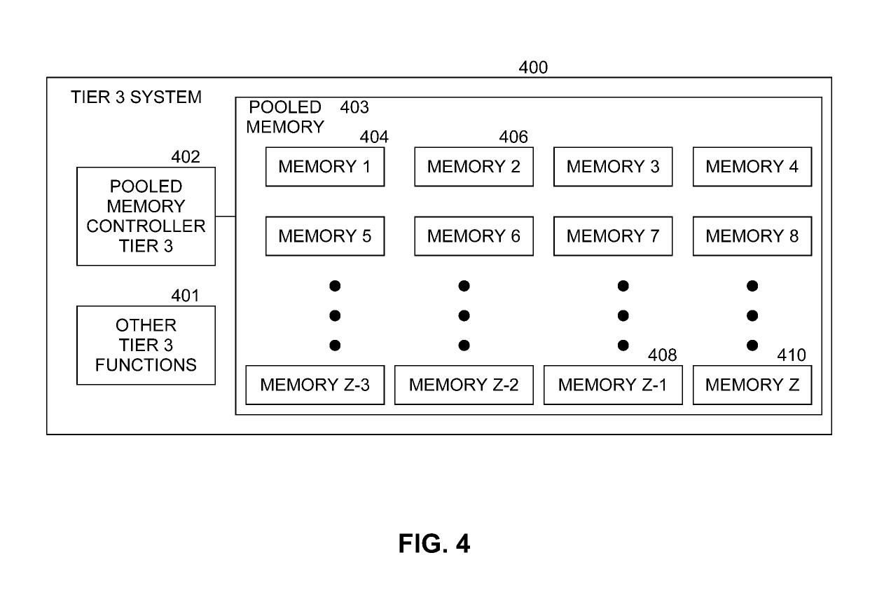

FIG. 4 illustrates an example of a tire 3 system. Tier 3 system 400 may include other tier 3 functions 401 to perform central office operations as is known in the art. In embodiments of the present invention, tier 3 system 400 may also include a pooled memory controller tier 3 component 402 and pooled memory 403. A pooled memory controller comprises logic to manage access to a pooled memory 403 within a tier system, such as tier 3 system 400. Pooled memory 403 includes one or more byte addressable memory devices such as memory 1 404, memory 2 406, . . . memory Z-1 408, and memory Z 410, where Z is a natural number. In an embodiment, the number of memories Z in a tier 3 system (e.g., a central office) may be more than the number of memories Y in a tier 2 system (e.g., a base station). Pooled memory 403 may include memory that may be accessed by other tier 2 or tier 3 systems communicatively coupled to this tier 3 system. That is, other tier 2 or tier 3 systems may read hot data from and/or write hot data to any one or more of the memories.

In some examples, any memory within pooled memory 403 may include volatile types of memory including, but not limited to, random-access memory (RAM), dynamic RAM (D-RAM), double data rate (DDR) SDRAM, SRAM, T-RAM or Z-RAM. One example of volatile memory includes DRAM, or some variant such as SDRAM. A memory subsystem as described herein may be compatible with a number of memory technologies, such as DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (LPDDR version 5, currently in discussion by JEDEC), HBM2 (HBM version 2, currently in discussion by JEDEC), and/or others, and technologies based on derivatives or extensions of such specifications.

However, examples are not limited in this manner, and in some instances, any memory within pooled memory 403 may include non-volatile types of memory, whose state is determinate even if power is interrupted to a memory. In some examples, memory may include non-volatile types of memory that is a block addressable, such as for NAND or NOR technologies. Thus, memory can also include a future generation of types of non-volatile memory, such as a 3-dimensional cross-point memory (3D XPoint™ commercially available from Intel Corporation), or other byte addressable non-volatile types of memory. According to some examples, memory may include types of non-volatile memory that includes chalcogenide glass, multi-threshold level NAND flash memory, NOR flash memory, single or multi-level Phase Change Memory (PCM), a resistive memory, nanowire memory, FeTRAM, MRAM that incorporates memristor technology, or STT-MRAM, or a combination of any of the above, or other memory.

Thus, embodiments of the present invention include pooled memory in the different tiers of the edge cloud architecture. Each pooled memory consists of a set of memory devices of a certain capacity, certain performance characteristics (i.e., amount of bandwidth) and certain functional characteristics (i.e., type of security, durability, reliability etc.) that are managed a memory controller.

Each tier provides a set of interfaces that can be used by edge devices to have access to a particular pooled memory in the computing system. In an embodiment, an edge device will have direct access only to the first interface (i.e., tier 1 (small cell) or tier 2 (base station). Requests targeting other pooled memory (for example in tier 3 (central office)) may be routed through the corresponding tiers to get to the targeted memory. For example, to allocate memory to a memory pool allocated in to the central office, the edge device may send the request to the small cell or base station, and the pooled memory controller in that location will automatically route the request to the central office.

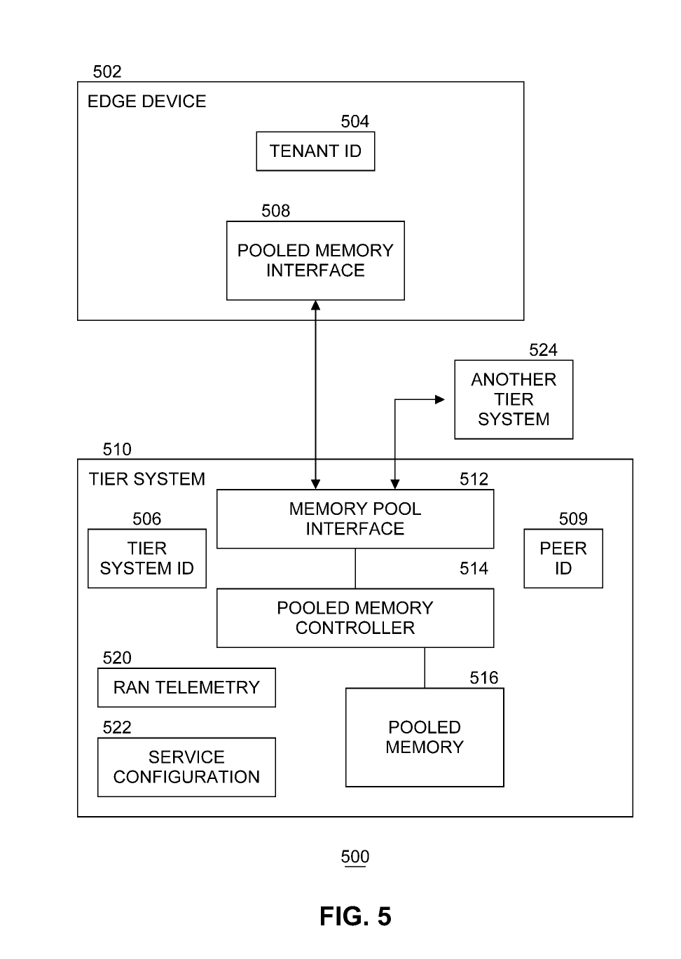

FIG. 5 illustrates an example 500 of an edge device 502 coupled to a tier system 510. In an embodiment, tier system 510 may be a tier 1 system (small cell) as shown in FIG. 2 or a tier 2 system (base station) as shown in FIG. 3. Edge device 502 may include a tenant identifier (ID) 504, which uniquely identifies a user or owner of the edge device. Tier system 510 includes a tier system ID 506, which uniquely identifies the tier level within the overall system (e.g., tier system ID=1 for small cells, tier system ID=2 for base stations). Tier system 510 also includes a peer ID, which is the unique identifier of this particular tier system. Application and/or operating system (OS) logic implemented in software, firmware, or hardware (not shown in FIG. 5) executing in edge device 502 may call pooled memory interface component 508 to manage access to pooled memory 516 in the computing system architecture. Pooled memory 516 may be representative of pooled memory 203 for a tier 1 system or of pooled memory 303 for a tier 2 system. Memory pool interface component 512 receives requests for managing and accessing pooled memory from pooled memory interface 508. Memory pool interface 512 in tier system 510 may also communicate with a corresponding memory pool interface in another tier system 524. Another tier system 524 may be a tier 1 system, tier 2 system, or a tier 3 system. Radio access network (RAN) telemetry component 520 as is known in the art. A RAN is part of a mobile telecommunication system. It implements a radio access technology. Conceptually, it resides between a device such as a mobile phone, a computer, or any remotely controlled machine and provides connection with its core network (CN). Depending on the standard, mobile phones and other wireless connected devices are varyingly known as user equipment (UE), terminal equipment, mobile station (MS), etc. RAN functionality may be provided by a silicon chip residing in both the core network (such as a tier system) as well as the edge device.

Tier system 510 also includes service configuration information 522. In an embodiment, service configuration 522 may be responsible to store and manage information corresponding to address ranges of memory assigned to and/or shared by edge devices. In an embodiment, this information may include the users of the computing system architecture (denoted by, for example, tenant IDs 504) owning a particular address range of memory, memory ranges allocated, sharing and access permissions (such as other edge devices that can access the particular address ranges), and metadata associated with a particular address range of memory (such as QoS requirements, SLA requirements, security information, etc.). Other information as needed for a particular computing system architecture may also be included in service configuration 522. In an embodiment, there is one virtual address space of pooled memory for the entire computing system architecture.

Tier system 510 includes pooled memory controller 514. Pooled memory controller 514 may be representative of pooled memory controller tier 1 202, pooled memory controller tier 2 302, and pooled memory controller tier 3 402. In an embodiment, the functionality, logic, and structure of pooled memory controller tier 1 202, pooled memory controller tier 2 302, and pooled memory controller tier 3 402 may be the same. In other embodiments, there may be some differences in functionality, logic, and structure between tier 1, tier 2, and tier 3 pooled memory controllers as a result of their place in the computing system architecture (i.e., in tier 1 (small cell), tier 2 (base station), and tier 3 (central office). Pooled memory controller 514 may be responsible for receiving requests from edge devices 502 to manage and access memory. Requests may be received via pooled memory interface 508 and memory pool interface 512 interactions. Pooled memory controller 514 implements logic to expose the memory pool interface 512. When receiving requests from edge devices 502 or another tier system 524, pooled memory controller 514 may request service configuration 522 to validate those requests based on information stored in service configuration 522. For example, Service Configuration 522 may validate that an edge device has permission to access a requested address in memory or get QoS/SLA parameters for a particular memory region to determine if such requirements are met. In an embodiment, pooled memory controller 514 may receive telemetry information from RAN telemetry 520 to determine that the edge device 502 is moving to another location, and thereby notify another tier system 524 that the other tier system may now be the best tier to handle edge device memory requests. In this scenario, pooled memory controller 514 may forward hot data in pooled memory 516 to another tier system's pooled memory.

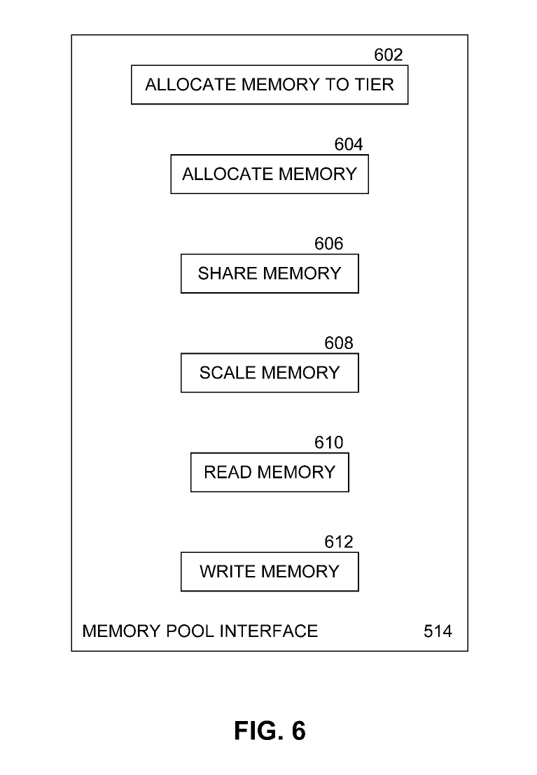

FIG. 6 illustrates an example set of memory pool interface operations. An edge device 502 may request to allocate memory in the computing system architecture to a particular tier system. The Allocate Memory to Tier interface 602 (Allocate Memory (Requirements, Tenant ID, Tier System ID)) may be used to allocate memory to a particular tier in the overall system identified by tier system ID. The Allocate Memory to Tier interface allows specifying what Tenant ID is performing the request as well as the requirements to the allocation (i.e., QoS/SLA, size of the requested memory, security etc.). The Allocate Memory interface 604 (Requirements, Tenant ID) provide the same functionality as the Allocate Memory to Tier interface 602 however for this interface the tenant (i.e., edge device) does not specify at what tier the memory needs to be allocated. In this case, memory pooled memory controllers based on the requirements will decide if the request is sent to another tier system or the requested memory is allocated in the tier system first receiving the request. In embodiments, requirements may include cost, latency, security etc.

The Share Memory interface 606 (Region ID, Tenant IDs, Permissions) allows an edge device to specify that a particular region in a particular memory is to be accessible by a list of edge devices having the specified Tenants IDs with particular permissions (i.e., Read, Write, or Read/Write). The Scale Memory interface 608 (Region ID, capacity/bandwidth, new memory requirements) allows an edge device to increase or decrease the amount of pooled memory associated to a region ID. In an embodiment, the Scale Memory interface may also allow an edge device to change characteristics such as QoS of a specified memory region. The Read Memory interface 610 (Virtual Address, Tenant ID, Tier System ID) allows an edge device to access, in a byte addressable mode, a particular memory line identified by virtual address which is owned or accessible to a particular Tenant ID. The Write Memory interface 612 (Virtual Address, Line, Tenant ID, Tier System ID) allows an edge device to write, in a byte addressable mode, to a particular memory line owned by or write accessible to a particular Tenant ID.

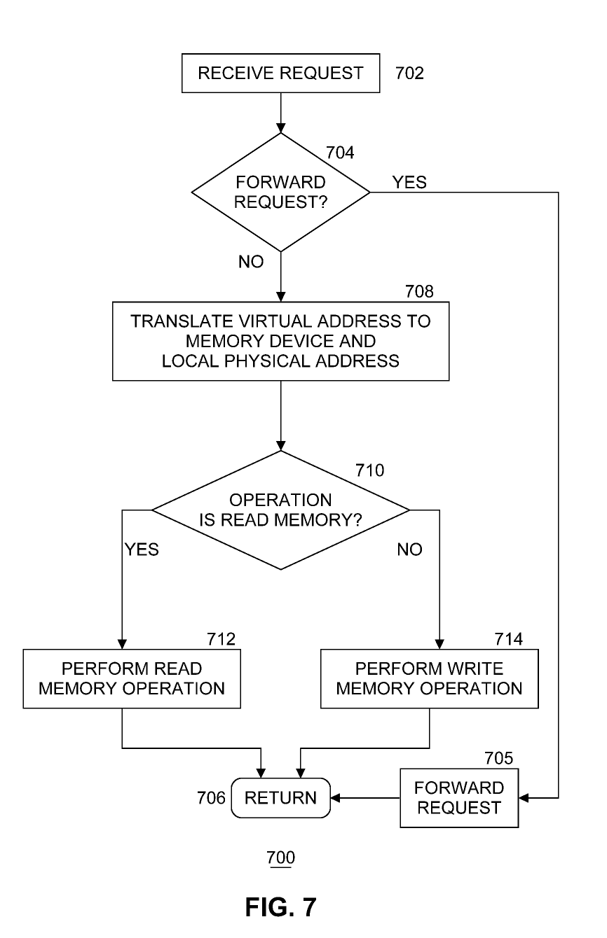

FIG. 7 illustrates an example logic flow of a pooled memory controller 514. Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

At block 702, pooled memory controller 514 may receive a request from an edge device. In an embodiment, the request may include a requested operation as shown in FIG. 6, a tenant ID, a virtual address, and an optional payload, optional peer ID, and an optional tier system ID. Pooled memory controller at block 704 determines if the request is to be forwarded to another tier system. If so, pooled memory controller forwards the request to the other tier system at block 705, and returns to the caller at block 706. In an embodiment, pooled memory controller may determine if the request is to be forwarded by checking if a) the tier system ID does not match the tier system ID of the tier system receiving the request; b) the peer ID does not match the peer ID of the tier system receiving the request; or c) the memory addressed by the virtual address is not to a memory within the pooled memory 516 of this tier system 510.

If the request is not forwarded at block 704, processing continues at block 708 where pooled memory controller 514 translates the virtual address to a memory device in pooled memory 516 and a local physical address within the memory device. In an embodiment, the memory device may be any memory in an edge device or in a tier 1 system. Next, at block 710 if the request is for a read memory operation, pooled memory controller performs the read memory operation at block 712. Otherwise, pooled memory controller performs a write memory operation at block 714 (using the payload as the data to be written to memory). In either case, processing ends with return 706. In the case of a read operation, the data read from memory is returned.

An example of pseudocode implementing operations of a pooled memory controller is shown below.

```
    --------------------------------------------------------------
    © 2018 Intel Corporation
    Pooled Memory Controller (operation, tenant ID, Virtual Address,
payload = optional, Peer ID = optional, tier system ID =optional)
    {
        //if the request has to be served by a tier above - i.e., the current
edge is base station and tier = Central Office, the request is
forwarded to the tier
          If (tier != LocalEdgeTier) then FowardRequest(tier,
          tenantID, VirtualAddress)
            Exit( );
          fi
          If (PeerID != LocalEdgeID) then
              FowardRequest(PeerID, tenantID, VirtualAddress)
            Exit( );
          fi
          WhereIsMemoryHosted= TranslateHome(VirtualAddress,
          TenantID);
          If WhereIsMemoryHosted != LocalEdgeID
          Then FowardRequest(WhereIsMemoryHosted, tenantID,
          VirtualAddress)
            Exit( );
          Fi
          (LocalPhysicalAddress, MemoryDevice) =
TranslatedVAToDevice&PhysicalMemory(tenantID, VirtualAddress)
          If (operation == ReadMemory)
          Then
            Result = performMemoryRead(LocalPhysicalAddress,
            MemoryDevice)
          Else
            Result = performMemoryWirte(LocalPhysicalAddress,
            MemoryDevice)
          Fi
          Return Result;
    }
    --------------------------------------------------------------
```

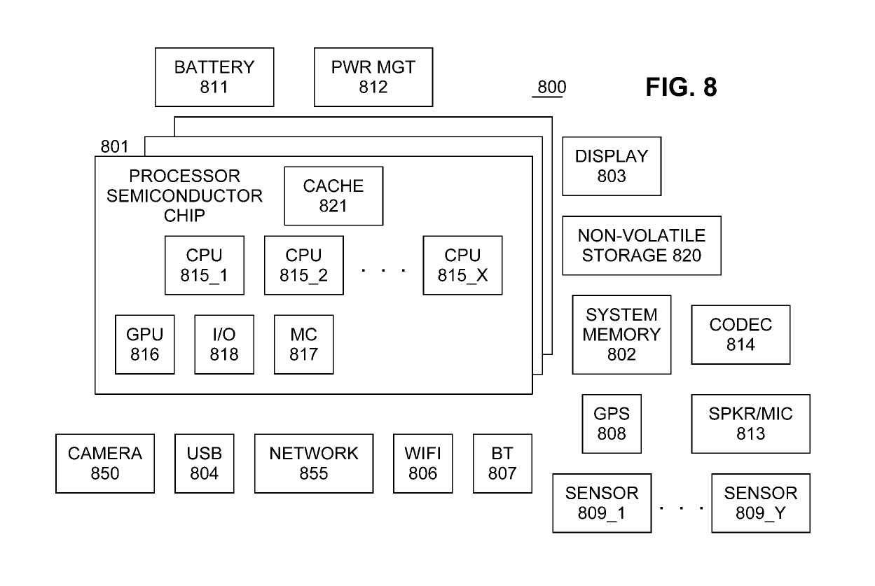

FIG. 8 illustrates an example second computing system. According to some examples, computing system 800 may include, but is not limited to, an edge device, a small cell, a base station, a central office switching equipment, a server, a server array or server farm, a web server, a network server, an Internet server, a work station, a mini-computer, a main frame computer, a supercomputer, a network appliance, a web appliance, a distributed computing system, a personal computer, a tablet computer, a smart phone, multiprocessor systems, processor-based systems, or combination thereof.

As observed in FIG. 8, the computing system 800 may include at least one processor semiconductor chip 801. Computing system 800 may further include at least one system memory 802, a display 803 (e.g., touchscreen, flat-panel), a local wired point-to-point link (e.g., USB) interface 804, various network I/O functions 855 (such as an Ethernet interface and/or cellular modem subsystem), a wireless local area network (e.g., WiFi) interface 806, a wireless point-to-point link (e.g., Bluetooth (BT)) interface 807 and a Global Positioning System (GPS) interface 808, various sensors 809_1 through 809_Y, one or more cameras 850, a battery 811, a power management control unit (PWR MGT) 812, a speaker and microphone (SPKR/MIC) 813 and an audio coder/decoder (codec) 814. The power management control unit 812 generally controls the power consumption of the system 800.

An applications processor or multi-core processor 801 may include one or more general purpose processing cores 815 within processor semiconductor chip 801, one or more graphical processing units (GPUs) 816, a memory management function 817 (e.g., a memory controller (MC)) and an I/O control function 818. The general-purpose processing cores 815 execute the operating system and application software of the computing system. The graphics processing unit 816 executes graphics intensive functions to, e.g., generate graphics information that is presented on the display 803. The memory control function 817 interfaces with the system memory 802 to write/read data to/from system memory 802.

Each of the touchscreen display 803, the communication interfaces 804, 855, 806, 807, the GPS interface 808, the sensors 809, the camera(s) 810, and the speaker/microphone codec 813, and codec 814 all can be viewed as various forms of I/O (input and/or output) relative to the overall computing system including, where appropriate, an integrated peripheral device as well (e.g., the one or more cameras 810). Depending on implementation, various ones of these I/O components may be integrated on the applications processor/multi-core processor 801 or may be located off the die or outside the package of the applications processor/multi-core processor 801. The computing system also includes non-volatile storage 820 which may be the mass storage component of the system.

Computing system 800 may also include components for communicating wirelessly with other devices over a cellular telephone communications network is as known in the art.

Various examples of computing system 800 when embodied as a small cell, base station, or central office may omit some components discussed above for FIG. 8.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A first tier system comprising:
a pooled memory controller coupled to a pooled memory having a plurality of memories, at least one edge device and at least one second tier system, the pooled memory controller including logic to
receive a request from one of the at least one edge device and the at least one second tier system to access the pooled memory, the request including a virtual address;
determine if the request is to be forwarded to the second tier system;
forward the request to the second tier system when the request is to be forwarded;
when the request is to not be forwarded, translating the virtual address to a local physical address of a selected memory of the pooled memory, and performing at least one of a read operation and a write operation on the local physical address of the selected memory of the pooled memory based on the request.

2. The first tier system of claim 1, wherein the first tier system comprises a small cell.

3. The first tier system of claim 1, wherein the second tier system comprises a base station.

4. The first tier system of claim 1, wherein the first tier system comprises a base station and the second tier system comprises a central office.

5. The first tier system of claim 1, wherein the plurality of memories comprise a plurality of byte addressable memories.

6. The first tier system of claim 1, wherein the at least one edge device comprises a mobile cellular telephone.

7. The first tier system of claim 1, comprising a service configuration component to store and manage address ranges of pooled memory assigned to the at least one edge device.

8. The first tier system of claim 1, comprising a radio access network (RAN) telemetry component to wirelessly communicate with the at least one edge device and the at least one second tier system.

9. The first tier system of claim 1, wherein a single virtual address space of the pooled memory is shared among the first tier system, the at least one second tier system, and the at least one edge device.

10. A method comprising:
receiving a request from one of at least one edge device and at least one tier system to access a pooled memory including a plurality of memories, the request including a virtual address;
determining if the request is to be forwarded to the at least one tier system;
forwarding the request to the at least one tier system when the request is to be forwarded; and
when the request is to not be forwarded, translating the virtual address to a local physical address of a selected memory of the pooled memory, and performing at least one of a read operation and a write operation on the local physical address of the selected memory of the pooled memory based on the request.

11. The method of claim 10, wherein the plurality of memories comprise a plurality of byte addressable memories.

12. The method of claim 10, wherein the at least one edge device comprises a mobile cellular telephone and the at least one tier system comprises a base station.

13. The method of claim 10, comprising storing and managing address ranges of pooled memory assigned to the at least one edge device.

14. The method of claim 10, wherein a single virtual address space of the pooled memory is shared among the at least one tier system and the at least one edge device.

15. A system comprising:
at least one first tier system including
a first pooled memory including a first plurality of memories; and
a first pooled memory controller coupled to the first pooled memory and at least one edge device, the first pooled memory controller including logic to
receive a first request from the at least one edge device to access the first pooled memory, the request including a first virtual address;
determine if the first request is to be forwarded;
forward the first request when the first request is to be forwarded;
when the first request is to not be forwarded, translating the first virtual address to a first local physical address of a first selected memory of the first pooled memory, and performing at least one of a read operation and a write operation on the first local physical address of the first selected memory of the first pooled memory based on the first request; and at least one second tier system including
a second pooled memory including a second plurality of memories; and
a second pooled memory controller coupled to the second pooled memory and at least one of at least one edge device and the at least one first tier system, the second pooled memory controller including logic to
receive a second request from one of the at least one edge device and the at least one first tier system to access the second pooled memory, the request including a second virtual address;
determine if the second request is to be forwarded;
forward the second request when the second request is to be forwarded;
when the second request is to not be forwarded, translating the second virtual address to a second local physical address of a second selected memory of the second pooled memory, and performing at least one of a read operation and a write operation on the second local physical address of the second selected memory of the second pooled memory based on the second request.

16. The system of claim 15, wherein the at least one first tier system comprises a small cell and the at least one second tier system comprises a base station.

17. The system of claim 15, wherein the at least one first tier system comprises a base station and the at least one second tier system comprises a central office.

18. The system of claim 15, wherein the plurality of memories comprise a plurality of byte addressable memories.

19. The system of claim 15, wherein the at least one edge device comprises a mobile cellular telephone.

20. The system of claim 15, wherein the at least one first tier system comprising a first service configuration component to store and manage address ranges of first pooled memory assigned to the at least one edge device, and wherein the at least one second tier system comprising a second service configuration component to store and manage address ranges of second pooled memory assigned to the at least one edge device.

21. The system of claim 15, wherein the at least one first tier system comprising a first radio access network (RAN) telemetry component to wirelessly communicate with the at least one edge device and the at least one second tier system, and wherein the at least one second tier system comprising a second radio access network (RAN) telemetry component to wirelessly communicate with the at least one edge device and the at least one first tier system.

22. The system of claim 15, wherein a single virtual address space of the pooled memory is shared among the at least one first tier system, the at least one second tier system, and the at least one edge device.

23. The system of claim 15, comprising:
at least one third tier system including
a third pooled memory including a third plurality of memories; and
a third pooled memory controller coupled to the third pooled memory and the at least one second tier system, the third pooled memory controller including logic to
receive a third request from the at least one second tier system to access the third pooled memory, the request including a third virtual address;
translate the third virtual address to a third local physical address of a third selected memory of the second pooled memory, and performing at least one of a read operation and a write operation on the third local physical address of the third selected memory of the third pooled memory based on the third request.

24. The system of claim 23, wherein the at least one first tier system comprises a small cell, the at least one second tier system comprises a base station, and the at least one third tier system comprises a central office.

25. The system of claim 24, a number of the third plurality of memories is more than the second plurality of memories, and a number of the second plurality of memories is more than the first plurality of memories.
